(19) United States
(12) Patent Application Publication
(10) Pub. No.: US 2008/0290655 A1
(43) Pub. Date: Nov. 27, 2008

(54) Polygonal tube rack connector

(76) Inventor: Chou-Lian Yang, Taichung (TW)

Correspondence Address: BIRCH STEWART KOLASCH & BIRCH, PO BOX 747, FALLS CHURCH, VA, 22040-0747, US

(21) Appl. No.: 11/802,377

(22) Filed: May 22, 2007

(51) Int. Cl. F16L 19/00

(52) U.S. Cl. 285/179.1; 285/24

(57) ABSTRACT

A polygonal tube rack connector includes a lid and a carrier incorporated to each other by means of multiple fasteners; multiple non-linear grooves are disposed on the connector to accommodate mounting of multiple linear tubes; a limiting hole being disposed to each groove to facilitate fast and direct insertion of a stud from a tube to secure the tube in the groove without slipping off; and the tube can be easily removed by loosening up those fasteners for replacement.

### FIELD OF THE INVENTION

The present invention is related to a tube rack connector, and more particularly, to one that is capable of connecting multiple tubes into a polygonal tube rack.

### BACKGROUND OF THE INVENTION

In a tubing process, a connector is needed, and the connector generally available in the market is related to a single part, e.g., L-connector or T-connector. However, two grooves in the L- or the T-connector are in lineal symmetry between each another to prevent from connecting multiple tubes into a polygonal tube rack.

### SUMMARY OF THE INVENTION

The primary purpose of the present invention is to provide an improved construction of a connector that allows connecting multiple tubes into a polygonal tube rack.

To achieve the purpose, the present invention is related to a curved connector comprised of an lid and a lower carrier comprised incorporated to each other by means of multiple fasteners with multiple groves 2D axially arranged in non-lineal symmetry to accommodate installation of linear tubes. Multiple limiting holes are disposed in the grooves to facilitate fast and direct insertion of a stud disposed on the tube without slipping off. To remove the tube, simply loosen up those fasteners.

The present invention is characterized in that once the tube end is inserted into in the groove of the connector, the tube directly slides in and an elastic member to secure the stud of the tube end to the limiting holes with subsequent connection of tubes to complete a polygonal tube rack.

### BRIEF DESCRIPTION OF THE DRAWINGS

FIG. 1 is an exploded view of a preferred embodiment of the present invention.

FIG. 2 is a perspective view showing multiple elastic members are disposed on one side of a lid of the preferred embodiment of the present invention.

FIG. 3 is an exploded view of another preferred embodiment of the present invention.

FIG. 4 is an exploded view showing another preferred embodiment yet of the present invention.

FIG. 5 is an exploded view showing another elastic member and a hollow tube of another preferred embodiment yet of the present invention.

FIG. 6 is a schematic view showing the present invention as assembled.

FIG. 7 is a schematic view showing multiple tubes are connected in series into a polygonal tube rack.

### DETAILED DESCRIPTION OF THE PREFERRED EMBODIMENTS

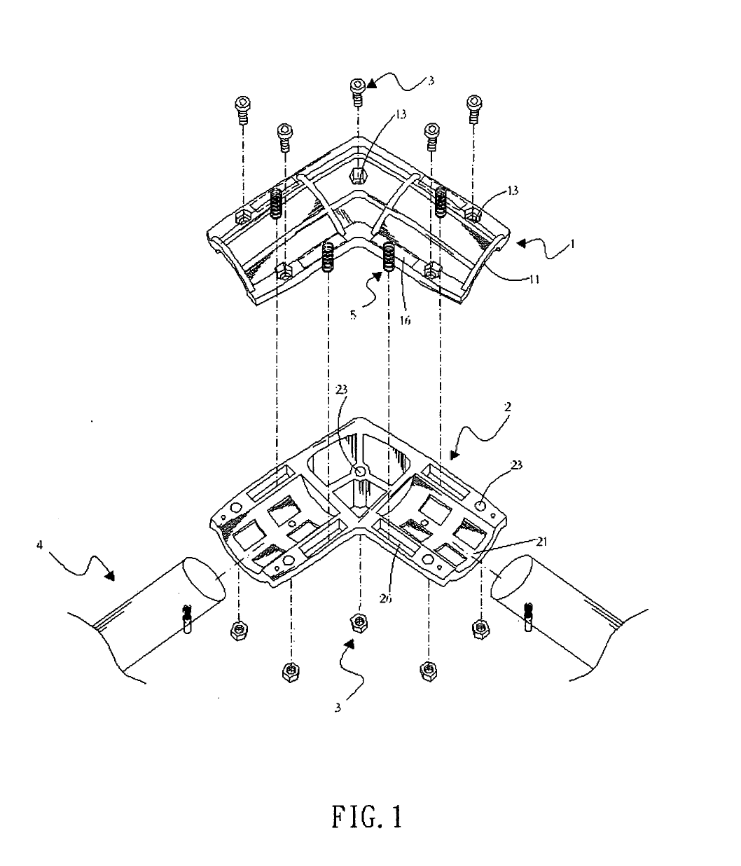

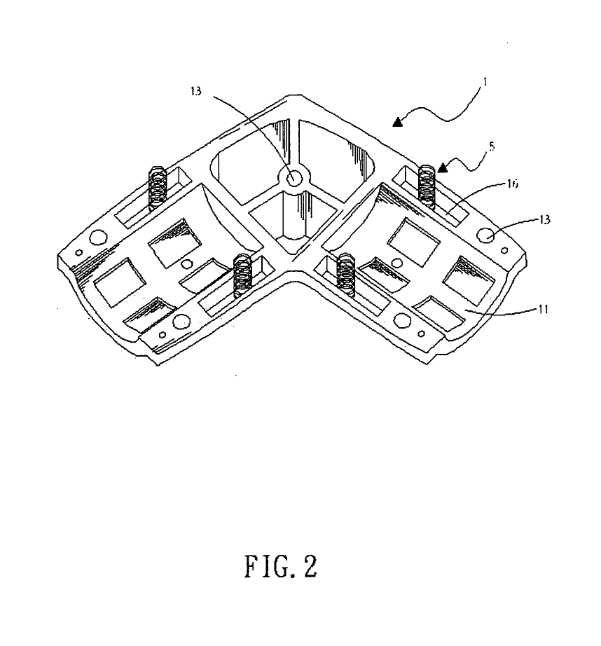

Referring to FIGS. 1 and 2, a preferred embodiment of the present invention is comprised of a lid (1), one side of the lid (1) is provided with two grooves (11), one locating hole (13) is each disposed on both sides of each the groove (11), and the center and/or the peripheral of the lid (1), a slot (16) for an elastic member (5) to pivot to is disposed by each locating hole (13) on both sides of the groove (11); a carrier (2) incorporated to the lid (1) is disposed with corresponding slots (21), connecting holes (23) and accommodation space (26); and multiple fasteners (3) are provided to insert through those locating holes (13) and connecting holes (23). Accordingly, the lid (1) and the carrier (2) are incorporated to each other, and one end of each elastic member (5) is pivoted to the slot (16) of the lid (1) and anther end of each elastic member (5) is confined in the accommodation space (26).

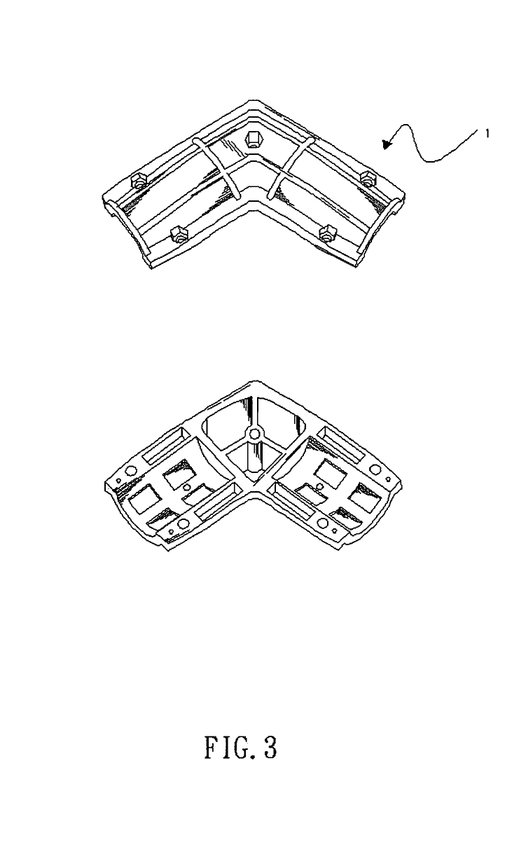

As illustrated in FIG. 1, assuming that the connector of the present invention is assembled and ready to connect to two tubes (4), those fasteners (3) are loosened up for a certain range without being removed from the connector. The lid (1) is lifted up for a certain height due to the elasticity exerted by the elastic member (5) pivoted to the slot (16) of the lid (1) to facilitate removing or replacing an existing tube (4), and the slot (16) corresponds to the accommodation space (26) of the carrier (2) to permit the elastic member (5) extending and being confined in the accommodation space (26). On the contrary, simply lock up once again those fasteners (3), and the lid (1) and the carrier (2) are incorporated with each other. Meanwhile, the lid (1) compresses the elastic member (5) for the latter to return to its packed status. Now referring to FIG. 3 for another preferred embodiment of the present invention, the elastic member (5) as illustrated in FIG. 1 is omitted.

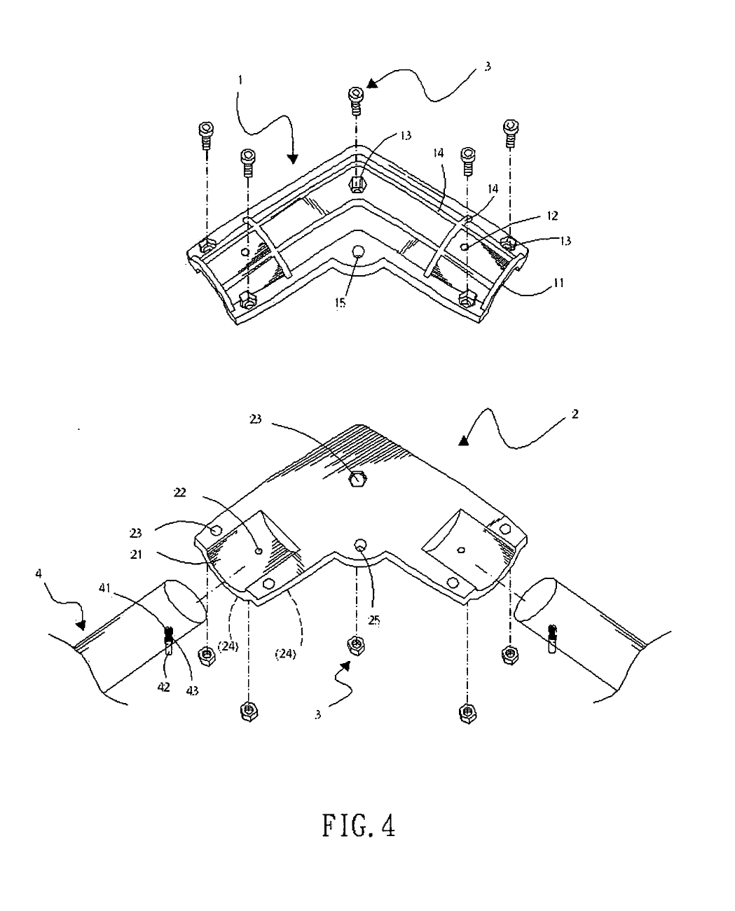

In another preferred embodiment yet of the present invention as illustrated in FIG. 4, the present invention includes a lid (1) provided on one side two grooves (11), a locating hole (13) is each disposed to both sides of the groove (11), and the center and/or the peripheral of the lid (1); a carrier (2) incorporated to the lid (1) is disposed of multiple slots (21) and connecting holes (23) corresponding to those grooves (11) and locating holes (13) of the lid (1); and multiple fasteners (3) insert through those locating holes (13) of the lid (1) and connecting holes (23) of the carrier (2).

An included angle not less than sixty degrees (60°) is 2D axially defined between each pair of the groove (11) and the slot (21). If the include angle is equal to 60°, three connectors and three tubes (4) are connected in series to one another; similarly, should the included angle be equal to 90°, four connectors and four tubes (4) are connected in series to one another; and so on in constituting a polygonal tube rack.

Each groove (11) or slot (21) has one open end and one closed end. The open end allows insertion of a tube (4) when the lid (1) and the carrier (2) are assembled to each other while the closed end allows the inserted tube (4) to hold tightly against it.

A limiting hole (12) (22) is provided to restrict the tube (4) since a through hole (41) on the proximate end of the tube (4) to the connector is disposed with a stud (42) to be inserted into the limiting hole (12) (22).

An elastic member (43) related to a coil or any other elastic object is connected at where between the stud (42) and the through hole (41).

Multiple alternatively arranged reinforcement ribs (14) (24) are disposed on the other side of each of the lid (1) and the carrier (2) to reinforce the structure and dissipate stress resulted from the assembly of the lid (1) and the carrier (2).

Another through hole (15) is disposed on one side of the lid (1), and another through hole (25) yet is disposed on one side of the carrier (2). Both through holes (15) (25) are provided for tying another object e.g., a rope.

One end of the stud (42) is connected to an elastic member (43); and one end of the elastic member (43) is further connected to a through hole (41) disposed on a surface of a proximate end of the tube (4) close to the connector. The stud (42) is pressed in the direction of the through hole (41) by finger of a user and the stud (42) will force the elastic member (43) to contract. Once the tube (4) fully enters into the groove (11) and the slot (21), the stud (42) is inserted into the limiting hole (12) (22).

As illustrated in FIGS. 1, 3, and 4, both of the lid (1) and the carrier (2) are incorporated to each other by means of multiple fasteners (3) for the groove (11) and the slot (21) to form a space to longitudinally receive one end of a tube; and the user has his finger to press the stud (42) to force the elastic member (43) to contract and then place the tube (4) into the groove (11) and the slot (21). Once the stud (42) is released, it will automatically holds against the most inner edge surfaces of the groove (11) and the slot (21). When the tube (4) further hold against the most inner edges of the groove (11) and the slot (21), the stud (42) is then ejected due to elasticity and inserted into the limiting hole (22) of the slot (21) of the carrier (2).

Upon those locating holes (13) disposed on both sides of the lid (1) are coupled to those connecting holes (23) disposed on both sides of the carrier (2), the locating hole (13) at the center of the lid (1) is coupled to the center connecting hole (23) of the carrier so that those limiting holes (12) (22) and both of the center locating and connecting holes (13) (23) are on the same central line with the tube (4). The tube (4) is secured by the connector at the lid (1) and both sides of the groove (11) and the slot (21), and the center locating hole (13) and the center-connecting hole (23) of the carrier (2) thus to achieve delta locking results provided by three fasteners (3). More locating holes (13) and connecting holes (23) may be further provided to the lid (1), the carrier (2), and the center and/or the peripheral of the center of the lid (1) and the carrier (2) to provide more reliable of the locking between the connector and the tube (4) by means of additional fasteners (3).

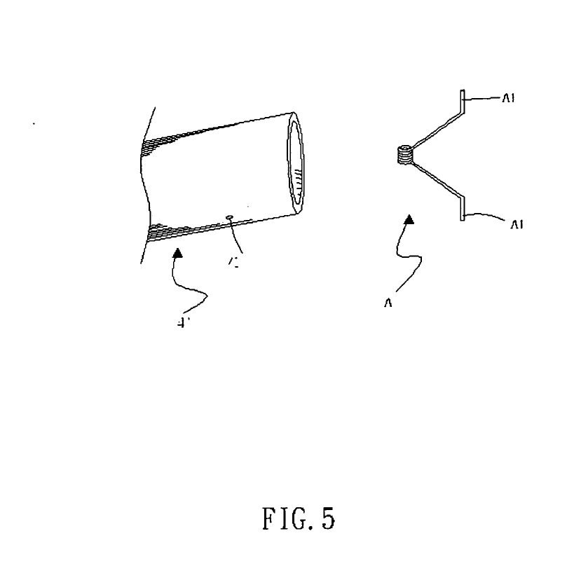

Now referring to the connector respectively illustrated in FIGS. 1 through 5, the elastic member (43) relates to a V-shaped elastic member (A) with both ends respectively formed with a stud (A1) to be inserted into a through hole (41) disposed on a surface of a hollow tube (4′) and the limiting hole (12) (22). The stud (A1) is made in a length sufficient to provide the purpose of the insertion as described above. Therefore, the user slightly presses both studs (A1) to facilitate insertion of the V-shaped elastic member (A) into an open end of the hollow tube (4′) with the tip of the V-shaped elastic member (A) facing in the direction of the hollow tube (4′) until both studs (A1) are inserted into the through hole (41) on the surface of the hollow tube (4′). When one end of the hollow tube (4′) is mounted to the connector, both studs (A1) are inserted into the limiting hole (22) and/or (12) to achieve the assembly and disassembly between the hollow tube (4′) and the connector.

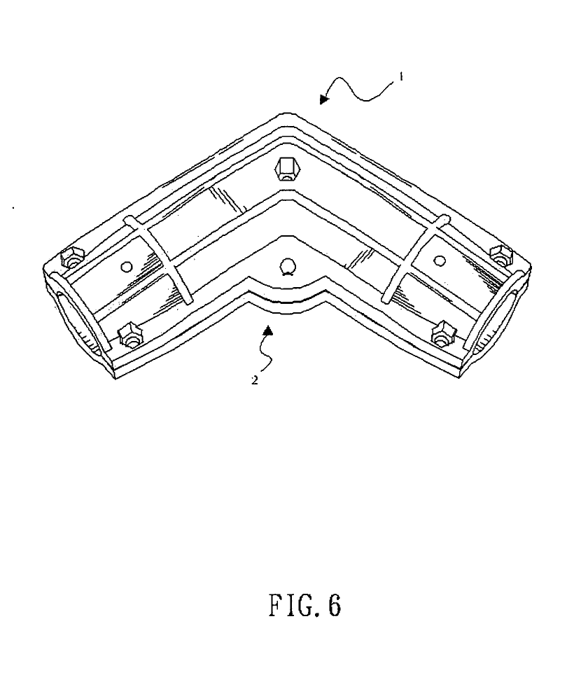

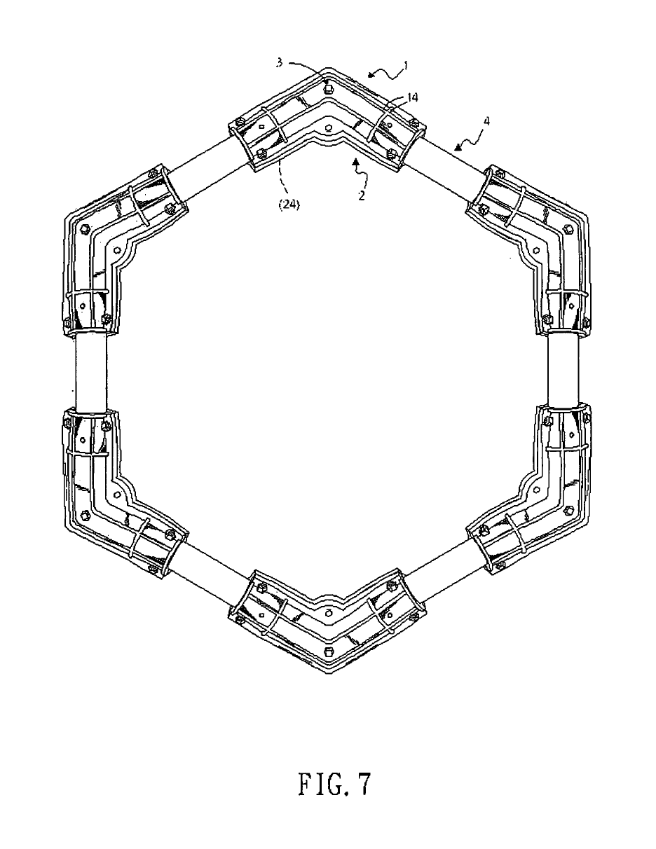

Finally, as illustrated in FIGS. 6 and 7, one end each of the lid (1) and the carrier (2) is designed in a curved shape to meet spatial requirements. For example, when six connectors and six tubes (4), twelve connectors and twelve tubes (4), or even more connectors and tubes (4) are connected in series into a polygonal tube rack, multiple fasteners (3) and reinforcement ribs (14) (24) are provided to disperse stress generated between tube (4) and connector to secure firm structure of the tube rack.

The prevent invention provides an improved structure of a polygonal tube rack connector, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A polygonal tube rack connector includes a lid containing on one side two grooves, multiple locating hole being disposed at the center and/or the peripheral of the lid, and one slot being disposed near to each locating hole on both sides of each groove for an elastic member to pivot to; a carrier incorporated to the lid being disposed with multiple slots, connecting holes, and accommodation spaces corresponding to those grooves, locating holes, and slots of the lid; and multiple fasteners inserting through locating holes and connecting holes.

2. A polygonal tube rack connector as claimed in claim 1, wherein an included angle not less than sixty degrees is 2D axially defined between those two grooves.

3. A polygonal tube rack connector as claimed in claim 1, wherein the groove has an open end and a closed end.

4. A polygonal tube rack connector as claimed in claim 1, wherein a limiting hole is disposed on the inner edge surface of the groove.

5. A polygonal tube rack connector as claimed in claim 1, wherein multiple reinforcement ribs are alternatively disposed on the other side of the lid and the carrier.

6. A polygonal tube rack connector as claimed in claim 1, wherein one side of the lid is disposed with a through hole.

7. A polygonal tube rack connector as claimed in claim 1, wherein one side of the carrier is disposed with a through hole.

8. A polygonal tube rack connector as claimed in claim 1, wherein the limiting hole restricts a tube.

9. A polygonal tube rack connector as claimed in claim 8, wherein a stud to insert into the limiting hole is disposed on a proximate end of the tube close to the connector; and an elastic member connects the stud and the groove.

10. A polygonal tube rack connector as claimed in claim 9, wherein the elastic member relates to a V-shaped elastic member with both ends each disposed with a stud to respectively insert into the through hole provided on a surface of the hollow tube and the limiting hole.
